(19) United States
(12) Patent Application Publication
(10) Pub. No.: US 2008/0253507 A1
(43) Pub. Date: Oct. 16, 2008

(54) Computed Tomography Detector Using Thin Circuits

(75) Inventors: Simha Levene, D. N. Hanegev (IL); Nicolaas J. van Veen, Geldrop (NL)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/067,942

(22) PCT Filed: Sep. 14, 2006
(86) PCT No.: PCT/IB06/53285

§ 371 Date: Mar. 25, 2008

Related U.S. Application Data
(60) Provisional application No. 60/596,595, filed on Oct. 5, 2005.

(51) Int. Cl. G01T 1/20

(52) U.S. Cl. 378/19

(57) ABSTRACT

An x-ray detector array (102) includes a plurality of detector elements or dixels (100). Each detector element includes a first scintillator (106₁) a second scintillator (106₂), a first photodetector (110₁), and a second photodetector (110₂). The first and second photodetectors (110₁, 110₂) are disposed at the side of the respective first and second scintillators (106₁, 106₂). The photodetectors (110₁, 110₂) of a plurality of detector elements (100) are carried by a circuit board (103) such as a thin flexible circuit.

The present invention relates to x-ray detector arrays for use in computed tomography (CT) systems. It also finds application to the detection of radiation other than x-radiation and in other medical and non-medical applications where arrays of radiation sensitive detectors are required.

CT scanners typically include a detector which receives x-radiation emitted by an x-ray tube. Single slice systems have traditionally included a one-dimensional array of detector elements arranged in a transverse arc facing the x-ray tube. Relatively more recently, multi-slice detectors have been developed, with an accurate, two dimensional array of detector elements extending in both the transverse and longitudinal directions.

Multi-slice or area CT scanners have a number of advantages relative to more traditional systems. For example, these scanners typically provide increased spatial resolution along the longitudinal or z-axis, increased scanning speed, the ability to scan relatively larger volumes, and improved utilization of the x-ray tube power. These advantages have, among other things, helped to facilitate the development of new clinical applications, thereby resulting in important enhancements to patient care.

With the wide acceptance of multi-slice CT scanners, there has been a trend to providing still an increased number of longitudinal slices and hence greater longitudinal coverage and spatial resolution. However, the trend toward ever larger detector arrays has complicated detector design. For example, the larger number of detector elements results in a relatively larger number of electrical signals which must be handled and routed. In addition, spaces or dead spots between detector elements can have various deleterious effects, such as the introduction of image artifacts, reduced dose utilization, and decreased spatial resolution. The relatively larger number of detectors has also become relatively expensive, and the need to efficiently manufacture and assemble the detectors has become increasingly acute.

Moreover, most CT systems have traditionally obtained radiation attenuation information over a single relatively wide energy range. While single energy systems have proven to be and remain extremely useful in a wide variety of clinical applications, they have limited ability to provide information about the material composition of the object under examination. Dual or multiple energy systems, on the other hand, utilize spectral information to provide material composition and other information about the object. One technique for obtaining multiple energy information is to use multiple detectors which provide multiple outputs indicative of radiation having more than one energy or energy range. As will be appreciated, however, such detectors lead to increased physical and electrical complexity, and provide still additional output signals. When coupled with the trend toward larger detector arrays, these issues become increasingly acute.

Aspects of the present invention address these matters, and others.

According to a first aspect of the present invention, an x-ray detector array includes a one-dimensional array of detector elements and a first circuit board. Each detector element includes a first scintillator and a first photodetector disposed to the side of and optically coupled to the first scintillator. The first photodetector receives light emitted by the first scintillator and produces an electrical signal in response thereto. A plurality of the first photodetectors are carried by the circuit board. The first photodetectors are disposed between the first circuit board and the side of the first scintillators.

According to a more limited aspect of the invention, the first circuit board comprises a flexible circuit having a thickness of 0.150 mm or less.

According to another aspect of the present invention, a radiation detector includes a first circuit board having a major surface; a scintillator array having a front which receives radiation, a side, and a back. The radiation detector also includes a photodetector array electrically connected to the circuit board and in optical communication with the scintillator array so as to receive light emitted thereby. The photodetector array is disposed between the scintillator array and the major surface of the circuit board.

According to another aspect of the present invention, an x-ray detector includes a flexible circuit and a plurality of x-ray detector elements. The flexible circuit has a thickness less than about 0.150 mm. Each detector element includes a first scintillator, a second scintillator disposed at a rear of the first scintillator and which receives x-radiation which has passed through the first scintillator. Each detector element also includes a first photodiode which is electrically connected to the flexible circuit and in optical communication with the first scintillator, as well as a second photodiode which is electrically connected to the circuit board and in optical communication with the second scintillator. The first photodiode is disposed between the first scintillator and the major surface of the flexible circuit. The second photodiode is disposed between the second scintillator and the major surface of the flexible circuit.

Still other aspects of the present invention will be appreciated by those skilled in the art upon reading and understanding the appended description.

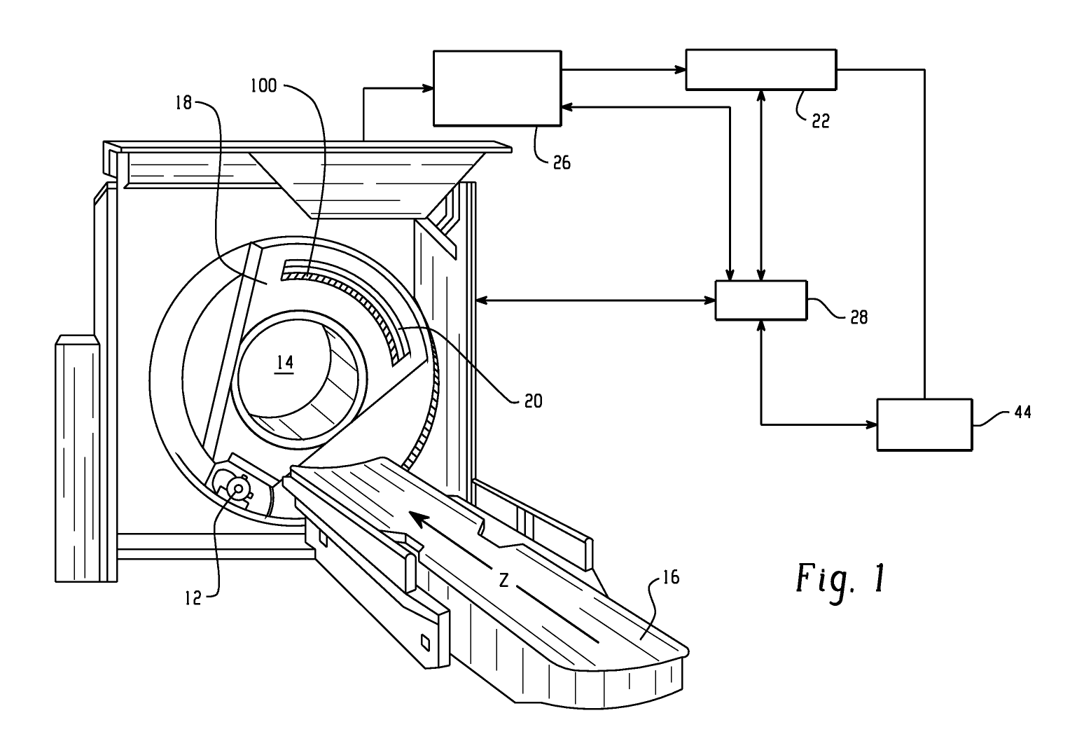

FIG. 1 depicts a CT system.

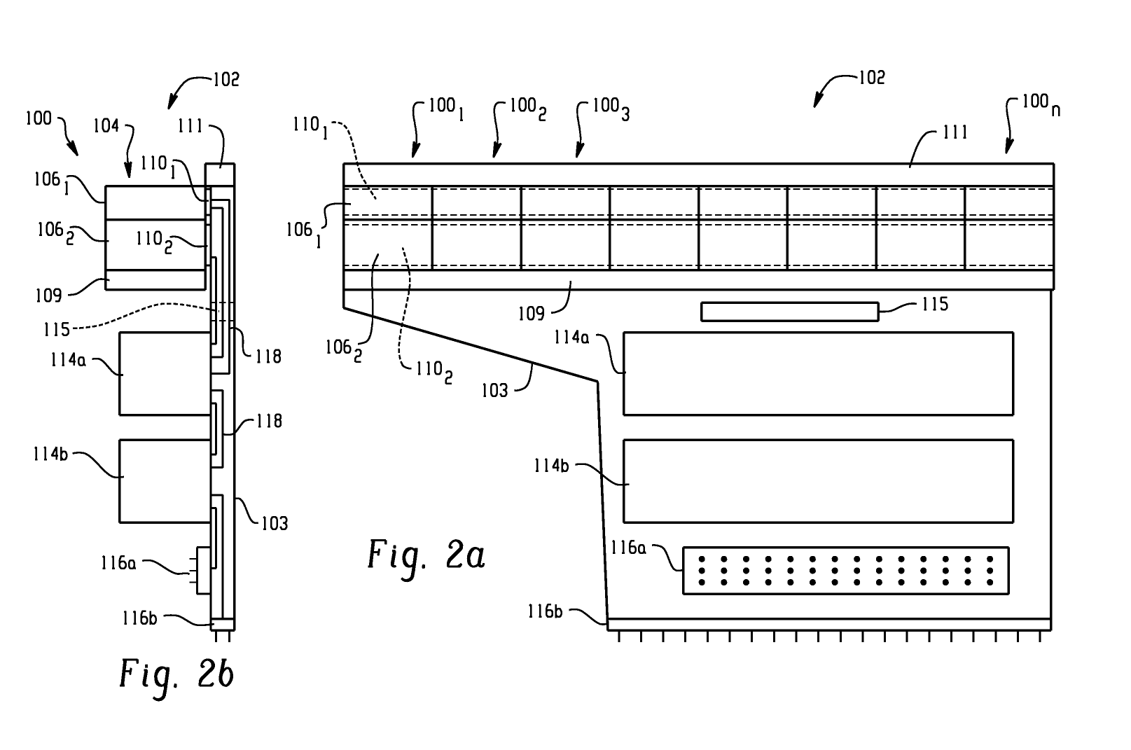

FIGS. 2a and 2b depict a detector array.

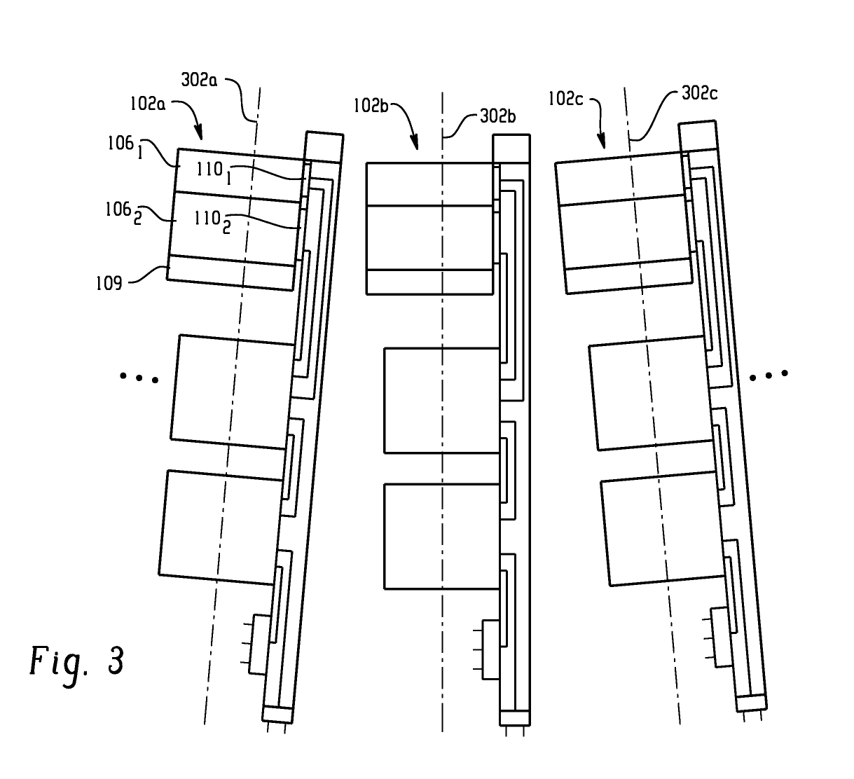

FIG. 3 depicts a plurality of detector arrays arranged to form an arcuate, two-dimensional array of detector elements.

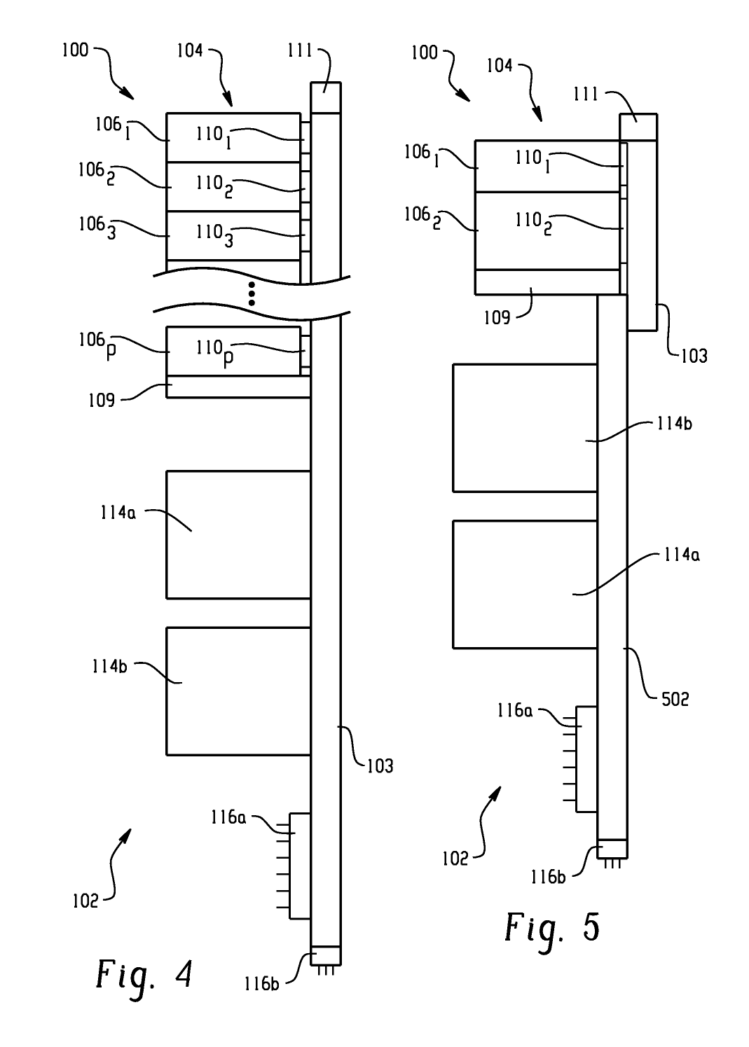

FIG. 4 depicts a portion of a detector array.

FIG. 5 depicts a detector array.

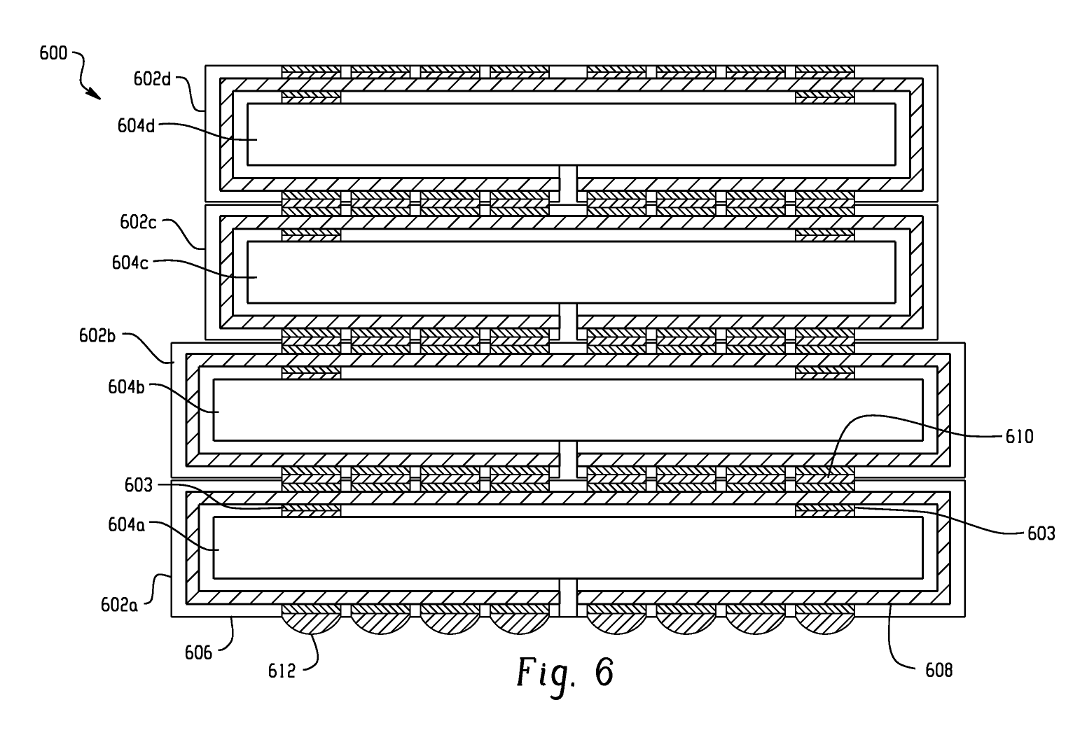

FIG. 6 is a cross sectional view of vertically stacked signal processing circuitry.

With reference to FIG. 1, a CT scanner includes a rotating gantry 18 which rotates about an examination region 14. The gantry 18 supports an x-ray source 12 such as an x-ray tube. The gantry 18 also supports an x-ray sensitive detector 20 which subtends an arc on the opposite side of the examination region 14. X-rays produced by the x-ray source 12 traverse the examination region 14 and are detected by the detector 20. Accordingly, the scanner 10 generates scan data indicative of the radiation attenuation along a plurality of projections or rays through an object disposed in the examination region 14.

A support 16 such as a couch supports a patient or other object in the examination region 14. The patient support 16 is preferably movable in the longitudinal or z-direction. In a helical scan, movement of the support 16 and the gantry 18 are coordinated so that the x-ray source 12 and the detectors 20 traverse a generally helical path relative to the patient.

The detector 20 includes a plurality of detector elements 100 disposed in an arcuate array extending in the transverse and longitudinal directions. In spectral CT, the detector 20 provides signals indicative of radiation detected at two or more energies or energy ranges. In the case of a single slice detector, the detector elements 100 are arranged in an arcuate array extending in the transverse direction.

Depending on the configuration of the scanner 10 and the detector 20, the x-ray source 12 generates a generally fan, wedge, or cone shaped radiation beam which is approximately coextensive with the coverage of the detector 20. Moreover, a so-called fourth generation scanner configuration, in which the detector 20 spans an arc of 360 degrees and remains stationary while the x-ray source 12 rotates, may also be implemented, as may detectors arranged in flat panel array. Moreover, in the case of a multi-dimensional array, the various detector elements 100 may be focused at the x-ray source 12 focal spot and hence form a section of a sphere.

A data acquisition system 26 preferably located on the rotating gantry 18 receives signals originating from the various detector elements 100 and provides necessary multiplexing, interface, data communication, and similar functionality. A reconstructor 26 reconstructs the data to generate volumetric data indicative of the interior anatomy of the patient. In addition, the data from the various energy ranges is processed (before reconstruction, after reconstruction, or both) to provide information about the material composition of the object under examination.

A controller 28 coordinates the various scan parameters as necessary to carry out a desired scan protocol, including x-ray source 12 parameters, movement of the patient couch 16, and operation of the data measurement system 26.

A general purpose computer serves an operator console 44. The console 44 includes a human-readable output device such as a monitor or display and an input device such as a keyboard and mouse. Software resident on the console allows the operator to control the operation of the scanner by establishing desired scan protocols, initiating and terminating scans, viewing and otherwise manipulating the volumetric image data, and otherwise interacting with the scanner.

Turning now to FIGS. 2a and 2b, a detector array 102 includes a plurality of detector elements 100₁, 100₂, 100₃, . . . 100ₙ each connected to a circuit board 103. Each detector element or dixel 100 has a front or radiation sensitive face 104 for receiving radiation and includes one or more scintillators 106 and one or more photodetectors 110.

The first 106₁ and second 106₂ scintillators are disposed in sequence from the front toward the rear of each detector element 100.

The geometry and materials of the first 106₁ and second 106₂ scintillators are preferably selected so that the first scintillator 106₁ is preferentially responsive to x-radiation having a relatively lower energy, while the second scintillator 106₂ is relatively more responsive to higher energy x-radiation. In one embodiment, the first scintillator 106₁ is fabricated from a material such as zinc selenide doped with tellurium (ZnSe:Te), cadmium tungstate (CdWO₄ or CWO), or yttrium aluminum garnet (YAG) and the second scintillator 106₂ is fabricated from gadolinium oxy sulfide doped with Pr (Gd₂O₂S:Pr or GOS). Other materials and combinations of materials are also contemplated.

When viewed from the front 104, each of the scintillators 106 has dimensions of approximately 1 mm by 1 mm, although other dimensions may be implemented depending on the needs of a particular application.

Disposed adjacent a side of and in optical communication with the first scintillator 106₁ is a first photodetector 110₁ responsive to light of the wavelength emitted by the first scintillator 106₁. Disposed adjacent a side of and in optical communication with the second scintillator 106₂ is a second photodetector 110₂ responsive to light of the wavelength emitted by the second scintillator 106₂.

In one embodiment, the photodetectors 110 are silicon photodiodes having a thickness of about 0.030 mm, as thinner silicon becomes optically transparent. The photodiodes may also be relatively thicker, although increasing the thickness of the photodiodes increases the spacing between detector arrays 102 when arranged in a multi-dimensional array. Other photodetectors such as gallium arsenide (GaAs) or indium phosphide (InP) photodiodes, charge coupled detectors, or CMOS detectors are also contemplated.

In an arrangement particularly well suited for obtaining information with respect to three or more energy ranges, and with reference to FIG. 4, each detector element 100 may include three or more scintillators 106₁, 106₂, 106₃ . . . 106ₙ and three or more photodetectors 110₁, 110₂, 110₃ . . . 110ₙ disposed in order from the front 104 toward the rear of the detector element 100. Again, the scintillators 106 disposed nearer to the front 104 of the detector 100 are preferentially responsive to lower energy radiation, while those located nearer to the rear of the detector element 100 are preferentially responsive to higher energy radiation. In a three scintillator detector element 100, suitable materials would include ZnSe:Te, GOS, and LySO respectively, although different materials and combinations of materials are contemplated.

Moreover, and particularly where each detector element 100 is not required to provide spectral information, each detector element 100 may include only a single scintillator 106₁ and photodetector 110₁.

Returning to FIGS. 2a and 2b, a radiation shield 111 fabricated from a radiation attenuative material such as tungsten, molybdenum, or lead shields the photodetectors 106 from radiation incident from the source 12.

Suitable detector implementations are also described in Improved Detector Array for Spectral CT, filed Apr. 26, 2005, U.S. Application Ser. No. 60/674,905, and Double Decker Detector for Spectral CT, filed Apr. 26, 2005, U.S. Application Ser. No. 60/674,900, which are expressly incorporated by reference herein.

With continuing reference to FIGS. 2a, 2b, and 4 the respective photodetectors 110 of each of the plurality of detector elements 100₁, 100₂, 100₃, . . . 100ₙ are soldered, connected via a conductive epoxy, or otherwise electrically connected to the circuit board 103.

The circuit board 103 is preferably a flexible circuit which includes a polymer substrate constructed from a material such as polyimide (PI), a polyester such as polyethylene terephthalate (PET), or polyethelene napthalate (PEN). The substrate carries conductive traces 118 which may be etched in a layer of copper laminated to the substrate or printed in silver conductive ink. Other suitable substrate and conductive layers may also be used. Depending on the number and density of the electrical signals, the flexible circuit 103 may include one, two, or more circuit layers.

The thickness of the circuit board is preferably less than about 0.035 mm and somewhat less preferably up to about 0.150 mm. In an embodiment in which the circuit board has a total thickness of about 0.035 mm, the substrate has a thickness of about 0.025 mm while the conductive traces have a thickness of about 0.010 mm. In an embodiment in which the circuit board has a total thickness of about 0.070 mm, the substrate has a thickness of about 0.060 mm. In an embodiment in which the circuit board has a thickness of about 0.150 mm, the substrate has a thickness of about 0.140 mm. Relatively thicker circuit boards 103 may also be used, although increasing the thickness increases the spacing between the detector arrays 102 when disposed in a multi-dimensional detector array. Relatively thinner circuit boards 103 may also be implemented using relatively thinner substrates and/or circuit traces. Moreover, it may be desirable to select the substrate from commercially available thicknesses.

Signal processing circuitry 114a, 114b such as multiplexers, amplifiers, and analog to digital converters are included in one or more application specific integrated circuits which are also electrically connected to the circuit board 103. The signal processing circuitry 114 is disposed to the rear or the detector array 100 substantially behind the scintillators 106. Provided that the height of the signal processing circuitry 114 is less than the depth of the scintillators 106, (e.g. less than about 1 mm) the circuitry does not increase the thickness of the detector array 102.

In some embodiments of the invention, the signal processing circuitry 114a, 114b may be packaged using flexible carrier folded real chip size package (FFCSP) technology as described by Yamazaki, et al. in Real Chip Size Three-Dimensional Stacked Package, in IEEE Trans. On Advanced Packaging, Vol 28 No 3. August 2005. pp 397 et seq. and Real Chip Size 3-Dimensional Stacked Package, NEC Research and Development, Vol. 44, No. 3, July 2003. Such technology is marketed under the trademark FFCSP™ by NEC Electronics Corporation of Tokyo, Japan.

With reference to FIG. 6, two or more integrated circuits 604a, 604b, 604c, 604d are vertically stacked. A stacked package 600 includes two or more single chip packages 602a, 602b, 602c, 602d. Each single chip package 602 includes an integrated circuit 604 and a flexible circuit 606 made of a thermoplastic resin which surrounds copper circuit traces 608. A single chip package 602 is fabricated by forming gold stud bumps 603 (using the ball bump method and gold wire) on the interconnection pads of the integrated circuit 604. The integrated circuit 604 is flip-chip bonded to Ni/Au electrodes on the flexible circuit 606. The flexible circuit 606 is folded around the edges of the integrated circuit 604 and is stuck to the side and back of the integrated circuit 604. Multiple single chip packages 602 are electrically connected by way of solder bumps 610. The stacked package is electrically connected to the flexible circuit 103 by way of solder bumps 612.

Electrical connectors 116a, 116b provide electrical connections to the data management system 26 or other signal processing electronics. The conductive traces 118 provide the requisite electrical connections between the photodetectors 110, 112, signal processing circuitry 114, and electrical connectors 116. More particularly, the signal processing circuitry 114 receives signals from the photodetectors 110 associated with the various detector elements 100 in the detector array 102. By suitably multiplexing, amplifying, and converting these signals to digital form, the number of interconnections which are required to be connected through the connectors 116 can be reduced, and the resultant signals also become relatively impervious to noise. The signal processing circuitry may be carried by the circuit board 103 but it may, of course, be elsewhere.

A support 109 provides mechanical support and may be used to mount the detector array 102 in the detector 20. A keyway 115 may also be used to facilitate mounting and/or alignment of the detector array 102 in the detector 20. The detector array 100 may also be potted using an epoxy, silicone, or other suitable potting compound.

As noted above, the circuit board 103 is connected to a plurality of detector elements 100. While FIG. 2a depicts eight (8) detector elements 100 disposed in a 1×8 array, other particularly advantageous array sizes include 1×16, 1×32, or 1×64 arrays. Other larger or smaller arrays may be implemented, depending on the requirements of a particular application.

While the above discussion has focused on the components of each detector element 100, construction of the detector array 102 is simplified if the photodetectors 110 are fabricated as n×p photodiode arrays, where n is the number of detector elements 100 in the detector array 102, and p is the number of photodetectors 110 associated with each detector element or dixel 100. The scintillators 106, which may likewise be fabricated as one or more scintillator arrays, are bonded to the radiation sensitive faces of the respective photodetectors 110 using an optical adhesive to form a 1×n array of detector elements 100.

Particularly where the number n of elements 100 in the detector array 102 is large, construction of the detector array 102 may also be simplified if the photodetectors 110 are fabricated as two or more sub-arrays. The multiple sub-arrays and associated scintillators are connected to the circuit board 103 to form a detector array 102 having the desired number of elements.

In yet another arrangement, the detector array 102 includes an n×p array of photodetectors 110 and a plurality of circuit boards 103. Each circuit board is then connected to a subset of the n detector elements in the array.

According to still another arrangement, and with reference to FIG. 5, an additional circuit board 502 may be disposed generally behind the scintillators 106. The circuit board(s) 103 are then electrically connected to the additional circuit board 502. The signal processing circuitry 114 and connectors 116 are electrically connected to the circuit board 502.

A plurality of detector arrays 102 are preferably arranged in the detector 20 using a suitable mechanical mounting arrangement to form a two-dimensional array of detector element 100 having the desired transverse and longitudinal extent. In one embodiment, the keyways 115 aid in the registration of the detector arrays 102.

As noted above, the detector 20 preferably subtends an arc segment extending in the scanner's transverse plane. FIG. 3 depicts a plurality of detector arrays 102a, 102b, 102c viewed along the z-axis, or stated conversely, projected upon the scanner's transverse plane. In the case of a third generation scanner, the radiation receiving face 104a, 104b, 104c of each detector element 100 can be visualized as being substantially perpendicular to a line 302a, 302b, 302c which intersects the focal spot of the x-ray source 12 at a common distance therefrom. To minimize dead spots located between the detector arrays 102a, 102b, 102c, the transverse spacing between the detector arrays is minimized. As can be seen, minimizing the thickness of the respective photodetectors 110 and circuit boards 103 allows the detector arrays 102 to be placed relatively closer together. The geometry of the arrangement shown in FIG. 3 also allows the signal processing circuitry 114 to extend beyond the scintillators 106 without deleteriously affecting the transverse spacing of the detector arrays 102a, 102b, 102c. The detector arrays may also be disposed in the transverse direction.

Depending on the desired longitudinal extent of the detector 20, each detector array 100 may include the number n of elements sufficient to cover the desired longitudinal extent. Alternately, a plurality of detector arrays 102 may be stacked or tiled in the longitudinal direction to provide the desired longitudinal extent. It should also be noted that the detector arrays 102 may, if desired, be longitudinally offset so that the detector elements 100 in each slice are offset from one another.

Of course, modifications and alterations will occur to others upon reading and understanding the preceding description. It is intended that the invention be construed as including all such modifications and alterations insofar as they come within the scope of the appended claims or the equivalents thereof.

1. An x-ray detector array comprising:
a one-dimensional array of detector elements, each detector element including:
a first scintillator including a front which receives x-radiation, a rear, and a side; and
a first photodetector disposed to the side of and optically coupled to the first scintillator, wherein the first photodetector receives light emitted by the first scintillator and produces an electrical signal in response thereto; and
a first circuit board, wherein a plurality of the first photodetectors are carried by the first circuit board, and wherein the first photodetectors are disposed between the first circuit board and the side of the first scintillator.

2. The x-ray detector array of claim 1 wherein the first circuit board comprises a flexible circuit having a thickness of 0.150 mm or less.

3. The x-ray detector array of claim 2 wherein each detector element further comprises:
a second scintillator disposed to the rear of the first scintillator and including a front which receives x-radiation, a rear, and a side;
a second photodetector disposed to the side of and optically coupled to the second scintillator, wherein the second photodetector receives light emitted by the second scintillator and produces an electrical signal in response thereto, and wherein a plurality of the second photodetectors are electrically connected to the flexible circuit.

4. The x-ray detector array of claim 2 wherein each detector element further comprises:
a third scintillator disposed to the rear of the first scintillator and including a front which receives x-radiation, a rear, and a side;
a third photodetector disposed to the side of and optically coupled to the third scintillator, wherein the third photodetector receives light emitted by the third scintillator and produces an electrical signal in response thereto, wherein a plurality of the third photodetectors are carried by the flexible circuit.

5. The x-ray detector array of claim 1 wherein the first circuit board has a thickness of 0.150 mm or less.

6. The x-ray detector array of claim 5 wherein the first circuit board has a thickness of 0.070 mm or less.

7. The x-ray detector array of claim 6 wherein the photodetectors comprise photodiodes having a thickness of approximately 0.03 mm.

8. The x-ray detector array of claim 5 wherein the circuit board comprises a substrate and the substrate comprises PI, PEN, or polyester.

9. The x-ray detector array of claim 1 wherein the first photodetectors comprise photodiodes and wherein a plurality of the photodiodes are fabricated on a common substrate.

10. The x-ray detector array of claim 1 including a second circuit board, wherein a first plurality of the first photodetectors are carried by the first circuit board and a second plurality of the first photodetectors are carried by the second circuit board.

11. The x-ray detector array of claim 1 further including a plurality of x-ray detector arrays arranged to form a multi-dimensional director array.

12. The x-ray detector array of claim 11 wherein the multi-dimensional array is arcuate.

13. The x-ray detector array of claim 12 wherein the multidimensional array forms a section of a sphere.

14. The x-ray detector array of claim 1 further including a multiplexer carried by the first circuit board and in electrical communication with a plurality of the first photodetectors, wherein the multiplexer is disposed at a rear of the first scintillator.

15. The x-ray detector array of claim 14 further including a plurality of vertically stacked integrated circuits carried by the first circuit board.

16. A radiation detector array comprising:
a first circuit board having a major surface;
a scintillator array having a front which receives radiation, a side, and a back;
a photodetector array electrically connected to the circuit board and in optical communication with the scintillator array so as to receive light emitted thereby, and wherein the photodetector array is disposed between the scintillator array and the major surface of the first circuit board.

17. The detector array of claim 16 wherein the first circuit board has a thickness of 0.150 mm or less.

18. The detector array of claim 17 wherein the photodetector array has a thickness of approximately 0.030 mm.

19. The detector array of claim 17 wherein the thickness of the first circuit board is 0.070 mm or less.

20. The detector array of claim 19 wherein the thickness of the first circuit board is 0.035 mm or less.

21. The detector array of claim 20 wherein the first circuit board comprises a substrate and wherein the substrate comprises PI.

22. The detector array of claim 16 wherein the photodetector array and the scintillator array are two-dimensional arrays and wherein the photodetector array includes a first plurality of photodetectors disposed nearer the front of the scintillator array and a second plurality of photodetectors disposed nearer the back of the scintillator array.

23. The detector array of claim 16 wherein the photodetectors in the photodetector array are fabricated on a common substrate.

24. The detector array of claim 22 wherein the photodetector array includes a third plurality of detectors disposed between the first plurality of photodetectors and the second plurality of photodetectors.

25. The detector array of claim 16 wherein the scintillator array includes a plurality of scintillator elements and wherein the transverse dimension of each scintillator element is approximately 1 mm×1 mm.

26. The detector array of claim 16 including a second circuit board having a major surface, wherein a first plurality of photodetectors in the photodetector array are electrically connected to the first circuit board and a second plurality of photodetectors are electrically connected to the second circuit board.

27. The detector array of claim 16 including signal processing circuitry disposed at a rear of the scintillator array.

28. The detector array of claim 27 wherein the signal processing circuitry comprises a plurality of vertically stacked integrated circuits.

29. An x-ray detector comprising:
a flexible circuit having a thickness less than about 0.150 mm and a first major surface;
a plurality of x-ray detector elements, each detector element including:
a first scintillator including a front which receives x-radiation and a side;
a second scintillator disposed at a rear of the first scintillator and which receives x-radiation which has passed through first scintillator;
a first photodiode which is electrically connected to the flexible circuit and in optical communication with the first scintillator, and wherein the first photodiode is disposed between the first scintillator and the major surface of the flexible circuit;
a second photodiode which is electrically connected to the flexible circuit and in optical communication with the second scintillator, and wherein the second photodiode is disposed between the second scintillator and the major surface of the flexible circuit.

30. The x-ray detector of claim 29 including a plurality of x-ray detectors arranged to form a tiled detector array.
